(19) United States
(12) Patent Application Publication
(10) Pub. No.: US 2016/0324717 A1
(43) Pub. Date: Nov. 10, 2016

(54) Self-Administering Massage Device

(71) Applicant: Brett W. Burton, Boise, ID (US)

(72) Inventor: Brett W. Burton, Boise, ID (US)

(21) Appl. No.: 15/148,909

(22) Filed: May 6, 2016

Related U.S. Application Data
(60) Provisional application No. 62/157,556, filed on May 6, 2015.

(51) Int. Cl. A61H 7/00; A61H 23/00

(52) U.S. Cl. CPC A61H 7/001; A61H 23/00; A61H 2201/0207; A61H 2201/0214; A61H 2201/1685; A61H 2201/0126

(57) ABSTRACT

A self-administering massage device which provides a user the ability to massage and engage a variety of muscle groups without external aid. The device includes a track, a carriage, a locking mechanism, an interchangeable massage head, a first coupling link, a lockable hinge joint, a first quick lock-and-release mechanism. The track allows the interchangeable massage head to be positioned to a variety of height. The carriage is slidably engaged with the track and supports the interchangeable massage head. The locking mechanism is mechanically integrated into the slidable engagement of the carriage and the track in order to secure the carriage at the selected height. The interchangeable massage head is the component which applies the massage pressure. The lockable hinge joint and the coupling link removably couple the interchangeable massage head to the carriage. The lockable hinge joint allows for the interchangeable massage head to be positioned at an angled orientation.

The current application claims a priority to the U.S. Provisional Patent application Ser. No. 62/157,556 filed on May 6, 2015.

### FIELD OF THE INVENTION

The present invention relates generally to massage devices. More specifically, the present invention is a self-administering massage device that may be positioned and configured into a variety of heights and orientations. This allows a user to adequately apply significant amount of pressure to a variety of regions on the body.

### BACKGROUND OF THE INVENTION

Sports medicine groups can be understaffed when assisting teams with many athletes. Mobility devices allow athletes to be able to perform self-soft tissue mobilization and address muscular tightness by themselves, while the sports medicine providers can focus their time on higher priority cases. These devices, self-administering massage devices, allow for increased efficiency in the athletic training room. Currently there are existent devices which provide the user with the ability to perform a massage onto themselves. However, most of these devices are complicated to operate, costing the user time and effort. Additionally, current devices do not include an option to change or alter the pressure applying interface. Thus, if an individual would like to apply different type of massage pressures, he or she is forced to purchase a multitude of these devices.

It is therefore an objective of the present invention to introduce a self-mobility device that allows an individual to independently address muscular tightness and soft tissue restriction at any location on the body. The present invention allows for several mobility techniques to be performed. These techniques include but are not limited to: trigger point release, instrument assisted soft tissue mobilization, and mobilization with movement (active release therapy and pin and stretch). The present invention can be useful for different outlets which include but are not limited to: athletic training rooms, physical therapy clinics, fitness centers, sport teams (professional, college, high school, and youth), businesses with employees working desk jobs, and personal users. For example, baseball player would use the present invention in order to warm up and cool down in the clubhouse or bullpen in order to assist in decreasing soft tissue tightness following practice, games, and training. Overall, the present invention promotes good posture, functional movement, and can be used with or without resistance in conjunction with the soft tissue mobilization.

### BRIEF DESCRIPTION OF THE DRAWINGS

FIG. 1 is a perspective view of one of the embodiments of the present invention, wherein the track is an elongated structural member.

FIG. 2 is a top view of one of the embodiments of the present invention, wherein the track is the elongated structural member.

FIG. 3 is a perspective view of another embodiment of the present invention, wherein the carriage is attached to the side of the elongated structural member.

FIG. 4 is a perspective view of an alternative embodiment of the present invention, wherein the track is a wall-mounted beam.

FIG. 5 is an exploded view of the alternative embodiment of the present invention, wherein the track is the wall-mounted beam.

FIG. 6 is a perspective view of the alternative embodiment of the present invention illustrating a second coupling link and an extension rod.

### DETAIL DESCRIPTIONS OF THE INVENTION

All illustrations of the drawings are for the purpose of describing selected versions of the present invention and are not intended to limit the scope of the present invention.

The present invention is an alternative design for a self-administering massage device. More specifically, the present invention is a self-administering massage device that may be easily positioned into multiple configurations in order to allow a user to target and apply massage pressure to a wide range of muscle groups and body regions. The present invention uses the weight of the user to generate massage pressure. In other words, the user controls how much pressure is applied by varying the degree to which he or she lean against an interchangeable massage head 17. Additionally, the present invention allows the user to quickly and easily switch out the interchangeable massage head 17, thus further varying the intensity and type of massage pressure. For example, the present invention allows for the execution of several mobility techniques including, but not limited to, trigger point release, active release therapy, and pin and stretch. Furthermore, the use of the present invention promotes food posture and functional movement.

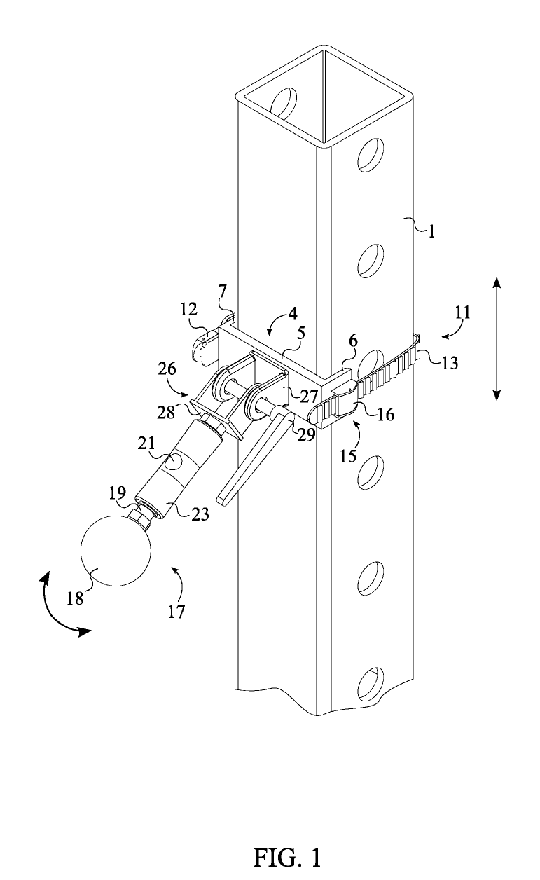

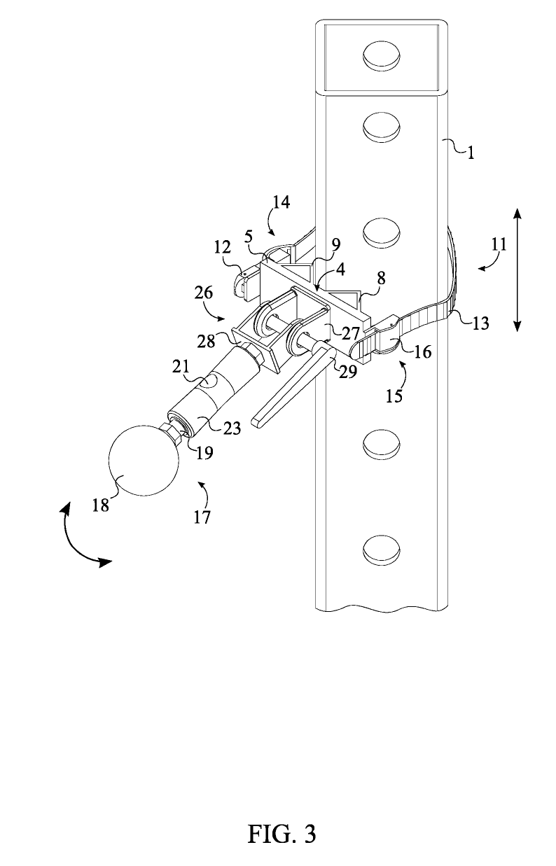

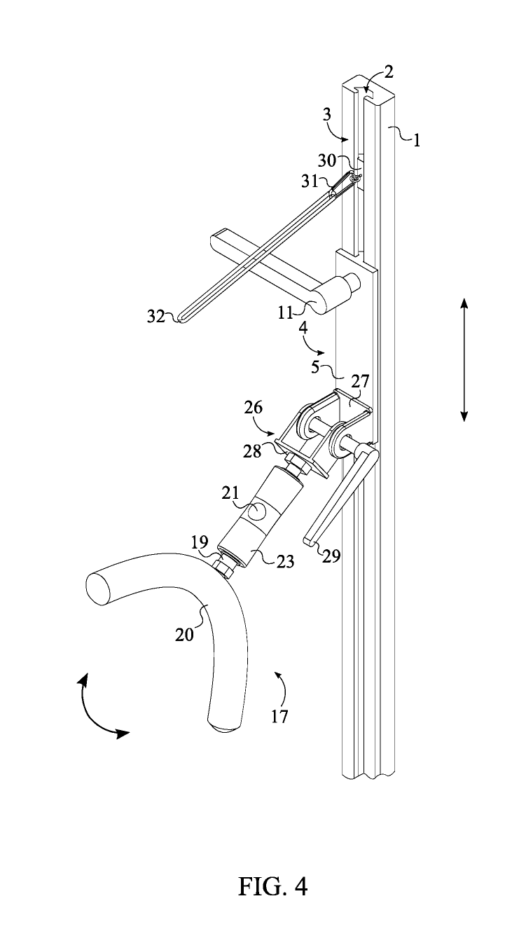

Referring to FIG. 1, FIG. 3, and FIG. 4, the present invention comprises a track 1, a carriage 4, a locking mechanism 11, an interchangeable massage head 17, a first coupling link 23, a lockable hinge joint 26, and a first quick lock-and-release mechanism 21. The track 1 provides a vertical path which the carriage 4 and its attached components may translate along. The carriage 4 slidably engages with the track 1 and subsequently allows the user to raise or lower the carriage 4 and the attached interchangeable massage head 17 to his or her preference. The locking mechanism 11 secures the carriage 4 to the track 1, ensuring that the interchangeable massage head 17 stays stationary during operations. More specifically, the locking mechanism 11 is mechanically integrated into the slidable engagement between the carriage 4 and the track 1. It is preferred that the locking mechanism 11 is a hand-operated mechanism such that the user can easily lock and release the carriage 4 without the need for special tools. The lockable hinge joint 26 provides an additional degree of freedom for the present invention, allowing the interchangeable massage head 17 to be positioned and locked at various angled orientations. The lockable hinge joint 26 is adjacently connected to the carriage 4, opposite the track 1.

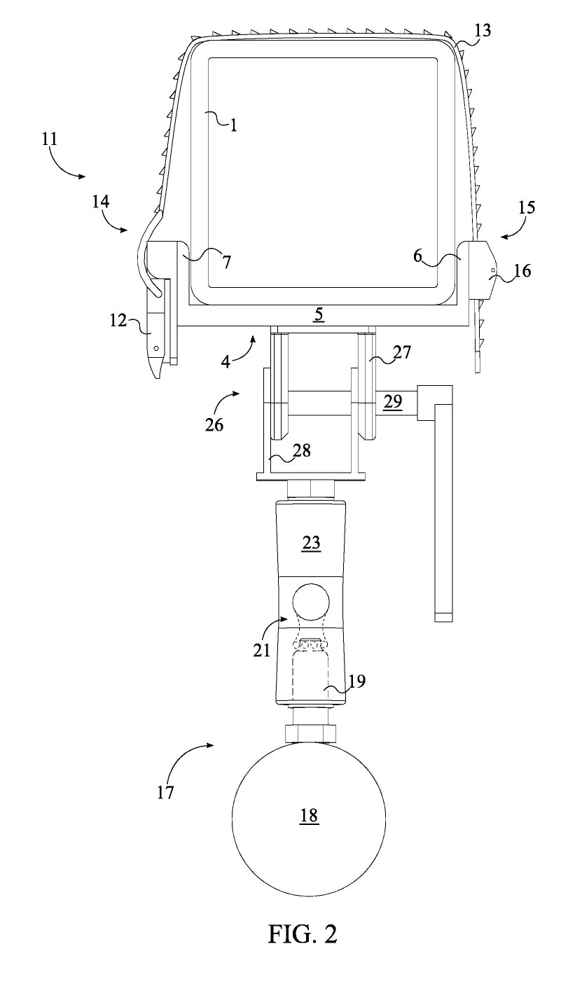

The first coupling link 23 and the first quick lock-and-release mechanism 21 removably connect the interchangeable massage head 17 to the lockable hinge joint 26. More specifically, the first coupling link 23 is a tubular extrusion that is adjacently connected to the lockable hinge joint 26, opposite the carriage 4. The first coupling link 23 may be used as a handle during massage exercises to better control the magnitude and location of the massage pressure produced by the present invention. As such, the outer surface of the first coupling link 23 may be covered by soft-grip material such as rubber. The interchangeable massage head 17 is the structure of the present invention which applies pressure onto a selected body region. The interchangeable massage head 17 is positioned opposite the carriage 4, across the first coupling link 23, and is mounted into the first coupling link 23 as seen in FIG. 2. The interchangeable massage head 17 may be implemented in a variety of shapes, designs, and sizes in order to vary the intensity and type of pressure produced by the present invention. The interchangeable massage head 17 is secured within the first coupling link 23 by the first quick lock-and-release mechanism 21. More specifically, the first quick lock-and-release mechanism 21 is mechanically integrated into the mounting of the interchangeable massage head 17 and the first coupling link 23 as seen in FIG. 2. It is preferred that an actuation button of the first quick lock-and-release mechanism 21 is integrated into the outer surface of the first coupling link 23 to provide the user with a quick means for actuating the first quick lock-and-release mechanism 21. A variety of mechanisms may be used for the first quick lock-and-release mechanism 21. In order to release the interchangeable massage head 17, the user simply pushes the actuation button and pulls the interchangeable massage head 17 out of the first coupling link 23.

Referring to FIG. 1, in one embodiment of the present invention, the interchangeable massage head 17 comprises a sphere head 18 and a coupling shaft 19. The sphere head 18 is a ball-like structure that serves as one of the primary massage pieces as it mimics the feel of the human thumb, thus allowing the user to massage a wide range of muscle groups. The coupling shaft 19 couples the sphere head 18 to the first coupling link 23. More specifically, the coupling shaft 19 is concentrically attached into the first coupling link 23 and is secured in place by the first quick lock-and-release mechanism 21. The coupling shaft 19 may contain a plurality of raised ridges or grooves that are sized and shaped to interlock with the first quick lock-and-release mechanism 21 to ensure a secure attachment. The sphere head 18 is adjacently connected to the coupling shaft 19, opposite the first coupling link 23. The size and material composition of the sphere head 18 are subject to change to fit the needs and preferences of the user. For example, a large sphere head 18 produces a less penetrating feeling that is ideal for massaging regions of the body that are more sensitive. Additionally, the external surface of the sphere head 18 may be textured to further create a more unique massage pressure.

Referring to FIG. 4, in one embodiment of the present invention, the interchangeable massage head 17 comprises a C-shaped head 20 and the coupling shaft 19. The C-shaped head 20 is a tubular structure that is bent into a C-shape. This shape allows the user to apply massage pressure to various regions of the body which share a similar contour, such as the shoulders, legs, and arms. The coupling shaft 19 connects the C-shaped head 20 to the first coupling link 23. More specifically, the coupling shaft 19 is concentrically attached into the first coupling link 23 and is secured in place by the first quick lock-and-release mechanism 21. The C-shaped head 20 is adjacently connected to the coupling shaft 19, opposite the first coupling link 23. More specifically, the coupling shaft 19 is positioned such that the coupling shaft 19 is bisecting the C-shaped head 20. Furthermore, the C-shaped head 20 is preferably oriented away from the coupling shaft 19. The size, curvature, and material composition are subject to change to fit the needs and preferences of the user. The present invention may also include alternative designs and shapes for the interchangeable massage head 17. For example, in alternative embodiments of the present invention, the interchangeable massage head 17 may include a vibrating feature, an electrical stimulation feature, a heating feature, a cooling feature, or any combination thereof.

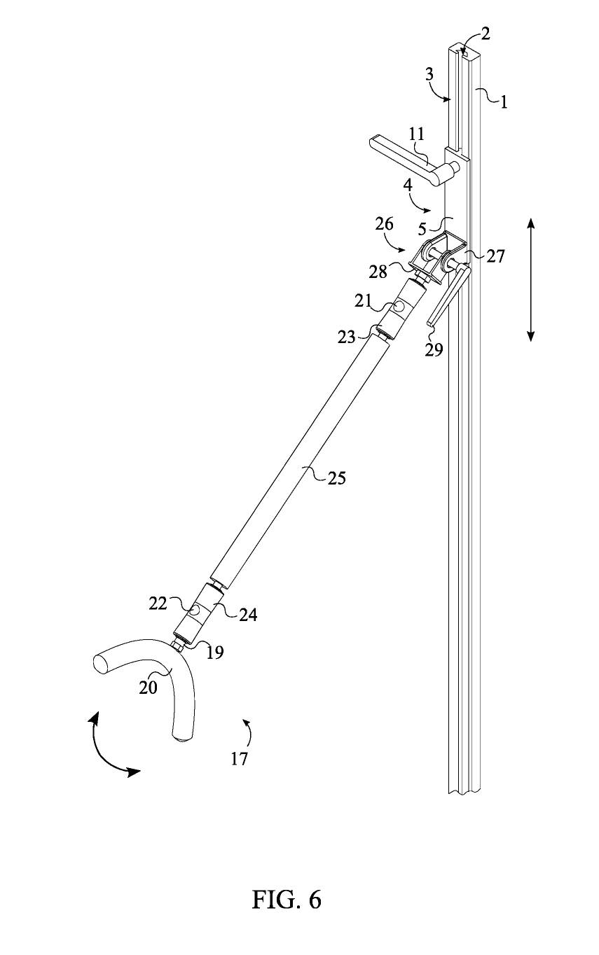

Referring to FIG. 6, the present invention allows the user to extend the interchangeable massage head 17 away from the track 1 through the use of a second coupling link 24, an extension rod 25, and a second quick lock-and-release mechanism 22. These components essentially act as an extension assembly in order to provide the user with clearance in between the track 1 and the interchangeable massage head 17. The provided clearance allows the user to position his or her body facing the track 1, engage the front of the body, and perform various movements to mobilize and engage the anterior muscle groups. This configuration is ideal for massaging and mobilizing muscles such as the anterior deltoids, the pectoralis minors, and other anterior muscle groups. The extension rod 25 is concentrically attached into the first coupling link 23, opposite the lockable hinge joint 26, and is secured by the first quick lock-and-release mechanism 21. The extension rod 25 may come in a variety of lengths to accommodate a variety of body sizes and user preferences. The second coupling link 24 is a tubular extrusion that receives the interchangeable massage head 17. In particular, the second coupling link 24 is adjacently connected to the extension rod 25, opposite the first coupling link 23. The interchangeable massage head 17 is attached into the second coupling link 24 and is secured in place by the second quick lock-and-release mechanism 22; the second quick lock-and-release mechanism 22 is mechanically integrated into the attachment of the second coupling link 24 and the interchangeable massage head 17. It is preferred that an actuation button of the second quick lock-and-release mechanism 22 is integrated into the outer surface of the second coupling link 24 to provide the user with a quick means for actuating the second quick lock-and-release mechanism 22.

Referring to FIG. 1, the lockable hinge joint 26 preferably comprises a first pivot mount 27, a second pivot mount 28, and a locking clamp 29. The first pivot mount 27 is a U-shaped structure that is adjacently connected to the carriage 4, oriented away from the carriage 4. The second pivot mount 28 is a U-shaped structure that is adjacent attached to the first coupling link 23, oriented away from the first coupling link 23. The first pivot mount 27 and the second pivot mount 28 are pivotably connected to each other such that when rotated, the second pivot mount 28 translates along an arc that is within a sagittal plane of the track 1. This allows the user to position the interchangeable massage head 17 at an angled orientation relative to the track 1 for massage purposes or for storage purposes. In alternative embodiments, the pivotable connection between the first pivot mount 27 and the second pivot mount 28 is oriented parallel to the track 1, thus rotating the lockable hinge joint 26 would translate the interchangeable massage head 17 to the left or right side of the track 1. The locking clamp 29 secures the lockable hinge joint 26 into a set configuration so the user may utilize the present invention. The preferred locking clamp 29 includes a handle that laterally extends away from the first pivot mount 27 and the second pivot mount 28. The handle provides the user an easy and quick means for locking and releasing the locking clamp 29. In alternative embodiments of the present invention, alternative types of mechanisms may be used for the locking clamp 29. Referring to FIG. 1 through FIG. 3, in one embodiment of the present invention, the track 1 is an elongated structural member. The elongated structural member is a tubular extrusion, preferably with a square cross-section. The elongated structural member may be any structure with similar characteristics found in a typical gym. In general, the elongated structural member is a tubular structure that is anchored by some means, allowing it to serve as an anchor point itself for the carriage 4 and the components attached to the carriage 4. In this embodiment, the carriage 4 comprises a slider plate 5, a first flange 6, and a second flange 7. The slider plate 5 presses up against the elongated structural member and serves as a mounting plate for the constituents of the present invention. The first flange 6 and the second flange 7 engage the sides of the elongated structural member and laterally stabilize the slider plate 5. The first flange 6 and the second flange 7 are positioned adjacent to the slider plate 5, opposite the lockable hinge joint 26. Additionally, the first flange 6 and the second flange 7 are perpendicularly connected to the slider plate 5. Furthermore, the first flange 6 and the second flange 7 are positioned opposite to each other across the slider plate 5. When viewed from the top perspective, the slider plate 5, the first flange 6, and the second flange 7 create a U-shape, seen in FIG. 2. The U-shape is designed to complement the shape of the elongated structural member in order to facilitate a flush junction in between the carriage 4 and the elongated structural member. More specifically, the carriage 4 is positioned such that the slider plate 5 is adjacent to the elongated structural member with the elongated structural member being in between the first flange 6 and the second flange 7 as seen in FIG. 2. This increases the contact surface in between the carriage 4 and the elongated structural member which aids the locking mechanism 11.

The locking mechanism 11 is mechanically integrated into the slidable engagement between the elongated structural member and the slider plate 5 in order to secure the carriage 4 to the elongated structural member. More specifically, in this embodiment, the locking mechanism 11 comprises a ratchet buckle 12, a ratcheting ladder strap 13, and a strap retainer 16. The ratchet buckle 12 receives and engages a first end 14 of the ratcheting ladder strap 13. The ratchet buckle 12 is laterally connected to the slider plate 5, adjacent to the second flange 7. The strap retainer 16 receives and engages a second end 15 of the ratcheting ladder strap 13. The strap retainer 16 is laterally connected to the slider plate 5, adjacent to the first flange 6. The ratcheting ladder strap 13 is positioned around the elongated structural member from the ratchet buckle 12 to the strap retainer 16, opposite the carriage 4. The ratcheting ladder strap 13 is constricted and tightened around the elongated structural member to a taut state, thus securing the carriage 4 at the set height. In order to release the locking mechanism 11, the user simply pulls on the ratchet buckle 12.

Referring to FIG. 3, in an alternative embodiment, the first flange 6 and the second flange 7 are replaced by a first triangular tooth 8 and a second triangular tooth 9. The first triangular tooth 8 and the second triangular tooth 9 allow for the carriage 4 to be attached to a corner of the elongated structural member. The first triangular tooth 8 and the second triangular tooth 9 are positioned adjacent to the slider plate 5, opposite the lockable hinge joint 26. Additionally, the first triangular tooth 8 and the second triangular tooth 9 are normally connected to the slider plate 5. Furthermore, the first triangular tooth 8 and the second triangular tooth 9 are positioned opposite to each other across the slider plate 5, thus creating a right angle in between which receives a corner of the elongated structural member. More specifically, the carriage 4 is positioned such that the slider plate 5 is adjacent to the elongated structural member with the elongated structural member being in between the first triangular tooth 8 and the second triangular tooth 9. In this embodiment, the ratchet buckle 12 is positioned adjacent to the second triangular tooth 9 and the strap retainer 16 is positioned adjacent to the first triangular tooth 8 as seen in FIG. 3.

Referring to FIG. 4 through FIG. 6, in one embodiments of the present invention, the track 1 is a wall-mounted beam and comprises a carriage-receiving channel 2. The wall-mounted beam allows the user to attach the present invention to any wall or other similar structure. This embodiment is ideal for in-home use and applications. The carriage-receiving channel 2 is shaped and sized to receive a portion of the carriage 4, thus interlocking the carriage 4 to the wall-mounted beam. The carriage-receiving channel 2 traverses through the wall-mounted beam, intersecting a front surface 3 of the wall-mounted beam. In this embodiment, the carriage 4 comprises the slider plate 5 and an interlocking foot 10. The interlocking foot 10 is connected normal to the slider plate 5, opposite the lockable hinge joint 26, and is the component which engages the carriage- receiving channel 2. More specifically, the interlocking foot 10 is oriented parallel to the carriage-receiving channel 2 and is slidably engaged with the carriage-receiving channel 2. The interlocking foot 10 is preferably a T-shaped extrusion such that when the interlocking foot 10 is slidably engaged with the carriage-receiving channel 2, the lateral arms prevent the disengaging of the interlocking foot 10 from the carriage-receiving channel 2. In this embodiment, the locking mechanism 11 is a screw clamp that is mechanically integrated into the slidable engagement between the slider plate 5 and the wall-mounted beam. Although, a variety of other comparable mechanisms may be used for the locking mechanism 11 in this embodiment. The handle of the screw clamp is preferably integrated into the slider plate 5 and faces away from the wall-mounted beam to provide the user with easy access. Rotating the handle clockwise will lock the carriage 4 at its current height. Rotating the handle counter clockwise will release the locking mechanism 11, the carriage 4, and will allow the user to adjust the height setting of the carriage 4 to his or her needs of preferences.

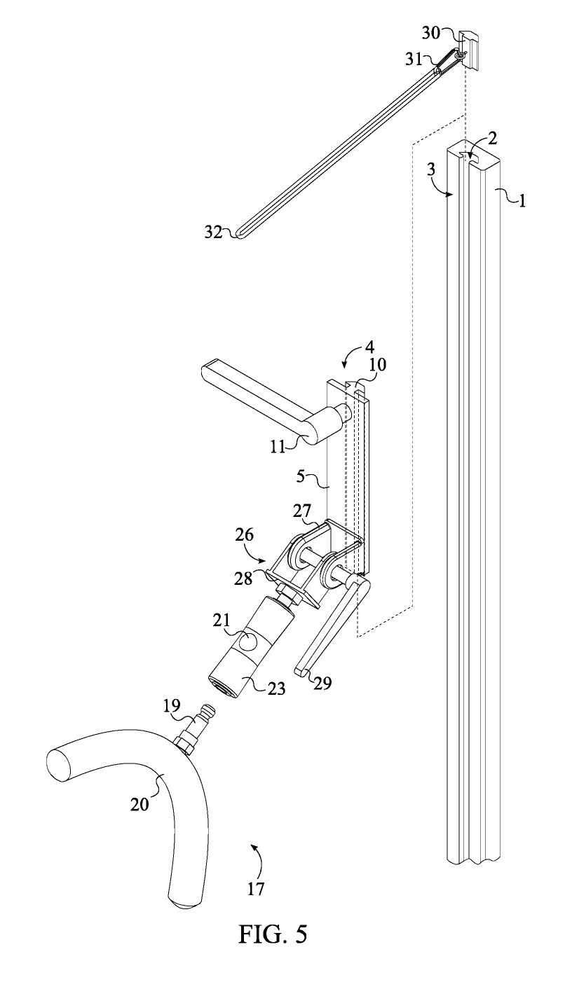

The present invention also allows the user to utilize bands in conjunction with the interchangeable massage head 17. This is achieved through the use of a slider 30, a carabiner 31, and a resistance band 32. The slider 30 translates within the carriage- receiving channel 2 and connects the resistance band 32 to the wall-mounted beam. More specifically, the slider 30 shares the same cross-section as the interlocking foot 10 and is slidably engaged with the carriage-receiving channel 2 as seen in FIG. 5 and FIG. 6. The carabiner 31 is adjacently attached to the slider 30, opposite the wall-mounted beam and allows the user to easily and quickly attach the resistance band 32. The present invention allows the user to attach any type of resistance band 32 by threading the resistance band 32 through the carabiner 31. The ability to translate the slider 30 allows for optimal line of pull when performing exercises with the resistance band 32. This facilitates contracting the antagonist while stretching agonist to further maximize impact.

Although the invention has been explained in relation to its preferred embodiment, it is to be understood that many other possible modifications and variations can be made without departing from the spirit and scope of the invention as hereinafter claimed.

1. A self-administering massage device comprises:
a track;
a carriage;
a locking mechanism;
an interchangeable massage head;
a first coupling link;
a lockable hinge joint;
a first quick lock-and-release mechanism;
the carriage being slidably engaged with the track;
the locking mechanism being mechanically integrated into the slidable engagement between the carriage and the track;
the lockable hinge joint being adjacently connected to the carriage, opposite the track;
the first coupling link being adjacently connected to the lockable hinge joint, opposite the carriage;
the interchangeable massage head being positioned opposite the carriage, across the first coupling link;
the interchangeable massage head being mounted into the first coupling link; and
the first quick lock-and-release mechanism being mechanically integrated into the mounting of the interchangeable massage head and the first coupling link.

2. The self-administering massage device as claimed in claim 1 comprises:
the interchangeable massage head comprises a sphere head and a coupling shaft;
the coupling shaft being concentrically attached into the first coupling link; and
the sphere head being adjacently connected to the coupling shaft, opposite the first coupling link.

3. The self-administering massage device as claimed in claim 1 comprises:
the interchangeable massage head comprises a C-shaped head and a coupling shaft;
the coupling shaft being concentrically attached into the first coupling link;
the C-shaped head being adjacently connected to the coupling shaft, opposite the first coupling link;
the coupling shaft bisecting the C-shaped head; and
the C-shaped head being oriented away from the coupling shaft.

4. The self-administering massage device as claimed in claim 1 comprises:
a second coupling link;
an extension rod;
a second quick lock-and-release mechanism;
the extension rod being concentrically attached into the first coupling link, opposite the lockable hinge joint;
the first quick lock-and-release mechanism being mechanically integrated into the attachment of the extension rod and the first coupling link;
the second coupling link being adjacently connected to the extension rod, opposite the first coupling link;
the interchangeable massage head being attached into the second coupling link; and
the second quick lock-and-release mechanism being mechanically integrated into the attachment of the second coupling link and the interchangeable massage head.

5. The self-administering massage device as claimed in claim 1 comprises:
the lockable hinge joint comprises a first pivot mount, a second pivot mount, and a locking clamp;
the first pivot mount being adjacently connected to the carriage;
the second pivot mount being adjacently attached to the first coupling link;
the first pivot mount being pivotably connected to the second pivot mount; and
the locking clamp being mechanically integrated into the pivotable connection of the first pivot mount and the second pivot mount.

6. The self-administering massage device as claimed in claim 1 comprises:
the track being an elongated structural member;
the carriage comprises a slider plate, a first flange, and a second flange;
the first flange and the second flange being positioned adjacent to the slider plate, opposite the lockable hinge joint;
the first flange and the second flange being positioned opposite to each other across the slider plate;
the first flange and the second flange being perpendicularly connected to the slider plate;
the elongated structural member being positioned adjacent to the slider plate, in between the first flange and the second flange; and
the locking mechanism being mechanically integrated into the slidable engagement between the elongated structural member and the slider plate.

7. The self-administering massage device as claimed in claim 6 comprises:
the locking mechanism comprises a ratchet buckle, a ratcheting ladder strap, and a strap retainer;
the ratchet buckle being laterally connected to the slider plate, adjacent to the second flange;
the strap retainer being laterally connected to the slider plate, adjacent to the first flange;
the ratcheting ladder strap being positioned around the elongated structural member from the ratchet buckle to the strap retainer, opposite the carriage;
a first end of the ratcheting ladder strap being engaged into the ratchet buckle; and
a second end of the ratcheting ladder strap being engaged into the strap retainer.

8. The self-administering massage device as claimed in claim 1 comprises:
the track being an elongated structural member;
the carriage comprises a slider plate, a first triangular tooth, and a second triangular tooth;
the first triangular tooth and the second triangular tooth being positioned adjacent to the slider plate, opposite the lockable hinge joint;
the first triangular tooth and the second triangular tooth being positioned opposite to each other across the slider plate;
the first triangular tooth and the second triangular tooth being normally connected to the slider plate;
the elongated structural member being positioned adjacent to the slider plate, in between the first triangular tooth and the second triangular tooth; and
the locking mechanism being mechanically integrated into the slidable engagement between the elongated structural member and the slider plate.

9. The self-administering massage device as claimed in claim 8 comprises:
the locking mechanism comprises a ratchet buckle, a ratcheting ladder strap, and a strap retainer;
the ratchet buckle being laterally connected to the slider plate, adjacent to the second triangular tooth;
the strap retainer being laterally connected to the slider plate, adjacent to the first triangular tooth;
the ratcheting ladder strap being positioned around the elongated structural from the ratchet buckle to the strap retainer, opposite the carriage;
a first end of the ratcheting ladder strap being engaged into the ratchet buckle; and
a second end of the ratcheting ladder strap being engaged into the strap retainer.

10. The self-administering massage device as claimed in claim 1 comprises:
the track being a wall-mounted beam and comprises a carriage-receiving channel;
the carriage comprises a slider plate and an interlocking foot;
the carriage-receiving channel traversing through the wall-mounted beam;
the carriage-receiving channel intersecting a front surface of the wall-mounted beam;
the interlocking foot being connected normal to the slider plate, opposite the lockable hinge joint;
the interlocking foot being oriented parallel to the carriage-receiving channel;
the interlocking foot being slidably engaged with the carriage-receiving channel; and
the locking mechanism being mechanically integrated into the slidable engagement between the slider plate and the wall-mounted beam.

11. The self-administering massage device as claimed in claim 10, wherein the locking mechanism is a screw clamp;

12. The self-administering massage device as claimed in claim 10 comprises:
a slider;
a carabiner;
a resistance band;
the slider being slidably engaged with the carriage-receiving channel;
the carabiner being adjacently attached to the slider, opposite the wall-mounted beam; and
the resistance band being threaded through the carabiner.
